(19) United States
(12) Patent Application Publication
(10) Pub. No.: US 2013/0101801 A1
(43) Pub. Date: Apr. 25, 2013

(54) OPTIMIZED STRINGER RUN-OUT ZONES IN AIRCRAFT COMPONENTS

(71) Applicants: Francisco Javier Honorato Ruiz, Madrid (ES); Jose Maria Pina Lopez, Alcorcon (ES); Pedro Nogueroles Vines, Esquivias (ES); Augusto Perez Pastor, Torrelodones (ES); Cesar Bautista De La Llave, Madrid (ES); Pablo Cebolla Garrofe, Getafe (ES); Alberto Arana Hidalgo, Madrid (ES); Aquilino Garcia Garcia, Madrid (ES); Jorge Juan Galiana Blanco, Madrid (ES); Ewa Aneta Glowacz, Madrid (ES); Alejandro Fernandez Alonso, Madrid (ES); Angel Garcia Sacristan, Madrid (ES); Carolina Elena Frias Fuentes, Madrid (ES)

(72) Inventors: Francisco Javier Honorato Ruiz, Madrid (ES); Jose Maria Pina Lopez, Alcorcon (ES); Pedro Nogueroles Vines, Esquivias (ES); Augusto Perez Pastor, Torrelodones (ES); Cesar Bautista De La Llave, Madrid (ES); Pablo Cebolla Garrofe, Getafe (ES); Alberto Arana Hidalgo, Madrid (ES); Aquilino Garcia Garcia, Madrid (ES); Jorge Juan Galiana Blanco, Madrid (ES); Ewa Aneta Glowacz, Madrid (ES); Alejandro Fernandez Alonso, Madrid (ES); Angel Garcia Sacristan, Madrid (ES); Carolina Elena Frias Fuentes, Madrid (ES)

(73) Assignee: AIRBUS Operations S.L., Getafe (ES)

(21) Appl. No.: 13/608,509

(22) Filed: Sep. 10, 2012

Related U.S. Application Data
(63) Continuation of application No. 13/350,052, filed on Jan. 13, 2012, now abandoned.

(30) Foreign Application Priority Data
Oct. 24, 2011 (ES) ES 201131711

(51) Int. Cl. B64C 3/18; B64C 1/06

(52) U.S. Cl. CPC B64C 3/182; B64C 1/064
USPC 428/167

(57) ABSTRACT

Aircraft component, such as an aircraft wing, that comprises at least one panel (11) of a composite material formed by a skin (13) and at least a stiffening stringer (15) configured by a web (17) and a foot (19) bonded to said skin (13); the stringer (15) having a run-out zone inside said panel (11) subjected to a high load level; the stringer (15) having a web (17) of decreasing height in said run-out zone and a foot (19) having a first section (31) of variable width from an initial value W1 to a final value W2 and a second section (33) with a width W2 in said run-out zone; the foot (19) and the web (17) of said stringer (15) having a decreasing thickness in said run-out zone for improving the load transfer from the stringer (15) to the skin (13).

### CROSS-REFERENCE TO RELATED APPLICATION

This application is a continuation of U.S. application Ser. No. 13/350,052 filed Jan. 13, 2012, which claims priority to Spanish Patent Application No. ES 201131711, filed on Oct. 24, 2011, the entire contents of each of which are hereby incorporated herein by reference in their entirety.

### FIELD OF THE INVENTION

The present invention refers to composite aircraft components and more in particular to high loaded stringer run-out zones in composite parts stiffened with stringers such as torsion boxes of aircraft lifting surfaces.

### BACKGROUND OF THE INVENTION

The main structure for aircraft lifting surfaces consists of a leading edge, a torsion box, a trailing edge, a root joint and a tip. The torsion box consists of several structural elements: upper and lower skins stiffened by stringers on one hand and spars and ribs on the other. Typically, the structural elements forming the torsion box are manufactured separately and are joined with the aid of complicated tooling to achieve the necessary tolerances, which are given by the aerodynamic, assembly and structural requirements.

Nowadays, and particularly in the aeronautical industry, composite materials with an organic matrix and continuous fibres, especially CFRP (Carbon Fibre Reinforced Plastic) are widely used in a great variety of structural elements. For example, all the elements which make up a torsion box enumerated beforehand (ribs, stringers, spars and skins) can be manufactured using CFRP.

The skins which make up the torsion boxes are stiffened with span wise longitudinal stringers bonded to them which improve both the strength and the buckling behavior of the skins having different cross sections such as “T”, “I” or “J” shaped cross sections. A constant height of the stringers benefits the stability of the panel by means of a bigger inertia in the stiffening element.

Typically the stringers are placed parallel to each other forming a certain angle with both front and rear spars. This configuration permits the orientation of the stringers along the maximum load direction as well as an increase in their number in the region with the greatest structural responsibility.

This configuration with parallel stringers, together with the fact that both spars are not parallel to each other, means that as the stringers get closer to the spar they are interrupted by the presence of said spar.

The end of a stringer, both due to the intersection with the front spar or due to any other reasons, cause a redistribution of the loads carried by the stringer and the skin before the termination onto just the skin panel (unstiffened) after the termination. This causes two main effects:

While the up-bending or down-bending of the stiffened skin causes tension and compression cases, this discrete change in the structural arrangement of the skin at the stringer termination (stringer run-out) causes a moment at the stringer run-out that tends to peel the bonding line between the stringer and the skin.

At the same time, the load redistribution has to take place through a bonding line through which the load carried by the stringer is transferred to the skin after the stringer run-out. In case of high load levels (as those experienced in a wing) the bonding strength is compromised.

The co-bonded joints between stringers and skins in the covers of the lateral wing torsion boxes of aircrafts which support hundreds of tons in the case of high payloads are close to their maximum structural capability in specific critical areas like the wing cover stringer run-out zones. These co-bonded joints can be broken just at the end of the stringer foot due to high peel loads caused by two main effects: the first one is the removal of the stringer web that causes the appearance of peeling efforts at the end of the stringer with a load peak in the place where the web is completely removed; and the second one is due to the end of the stringer foot that causes a shear load peak in the place where the stringer foot ends. In a typical stringer run-out configuration, the end of both stringer web and foot occurs at the same place, and both load peaks overlap, penalizing the structural reliability of the joint.

A known approach to solve these problems in, particularly, aircraft wings is riveting metallic plates to the end of the stringer to help to support said load peaks which involves a weight increase, the need of performing a mounting operation of said metallic plates and consequently an increase of the cost of the whole wing torsion boxes.

Other known proposals for stringer run-out zones such as those disclosed in U.S. Pat. No. 7,682,682, WO2008/132498 and WO 2011/086222 do not provide an optimized solution to the load transfer problems posed by high loaded stringer run-out zones in composite parts stiffened with stringers.

This invention is focused on the solution of said drawbacks.

### SUMMARY OF THE INVENTION

It is an object of the present invention to provide a stringer run-out arrangement able to transfer the loads to the skin avoiding peeling and de-bonding risks for an aircraft component having stringer run-out zones subjected to high loads.

It is another object of the present invention to provide a stringer run-out arrangement able to locally reduce the load carried by the stringer in a smooth way for an aircraft component having stringer run-out zones subjected to high loads.

These and other objects are met by an aircraft component that comprises at least one panel of a composite material formed by a skin and at least a stiffening stringer configured by a web and a foot bonded to said skin; the stringer having a run-out zone inside said panel subjected to a high load level; the stringer having a web of decreasing height in said run-out zone and a foot having a first section of variable width from an initial value W1 to a final value W2 and a second section with a width W2 in said run-out zone; the foot and the web of said stringer having a decreasing thickness (the decrement being preferably comprised between, respectively, the 60-80% and the 50-70%) in said run-out zone for improving the load transfer from the stringer to the skin.

In embodiments of the invention, said skin has an increased thickness in said run-out zone and said second section of the stringer comprises a first sub-section where the stringer web ends and a second sub-section without a stringer web. Hereby an optimized run-out arrangement using exclusively composite materials is achieved which can be used for ending high loaded stringers like those found in the covers of the lateral torsion boxes of aircraft wings which can be subjected to loads of hundreds of tons in the case of high payloads.

In embodiments of the invention where the skin has an increased thickness in said run-out zone, the aircraft component also comprises a rib having an intersection zone with said stringer in said run-out zone and the joining areas between said rib and said stringer are placed at said first sub-section. Hereby an optimized run-out arrangement is achieved by profiting from the increased width of the stringer foot in said sub-section.

In embodiments of the invention where the skin has an increased thickness in said run-out zone, several variables of the arrangement of the run-out zone such as the slope of the decrement of the thickness of the stringer foot, the beginning of the decrement of the thickness of the stringer foot, the variation of the width of the stringer foot or the variation of the height of the stringer web can take different values within predetermined ranges for meeting particular requirements.

In embodiments of the invention, the stringer web ends at the end of the run-out zone and said skin has an increased thickness in said run-out zone. Hereby an optimized run-out arrangement using exclusively composite materials is achieved which can be used for ending stringers subjected to high loads but of a lower level than those above-mentioned loads of hundreds of tons.

In embodiments of the invention where the stringer web ends at the end of the run-out zone, the aircraft component also comprises a rib having an intersection zone with said stringer in said run-out zone and the joining areas between said rib and said stringer are placed at the second section. Hereby achieved an optimized run-out arrangement is achieved by profiting from the increased width of the stringer foot in the second section.

In embodiments of the invention, the skin does not have an increased thickness in said run-out zone and said second section of the stringer comprises a first sub-section where the stringer web ends and a second sub-section without a stringer web. Hereby an optimized run-out arrangement using exclusively composite materials is achieved which can be used for ending stringers subjected to high loads but of a lower level than those above-mentioned loads of hundreds of tons.

Other characteristics and advantages of the present invention will be clear from the following detailed description of embodiments illustrative of its object in relation to the attached figures.

### DESCRIPTION OF THE FIGURES

FIG. 1 shows the typical structural configuration of a torsion box, except for the upper skin, which has been removed to improve the visibility of the interior.

FIG. 2 shows a portion of a skin of a typical torsion box where several stringers end close to the front spar.

FIGS. 3a, 3b and 3c are perspective, plan and cross sectional views of a stringer run-out arrangement according to a first embodiment of the present invention.

FIG. 4 is a plan view of a stringer run-out arrangement according to another embodiment of the present invention.

FIG. 5 is a plan view of a stringer run-out arrangement according to another embodiment of the present invention.

FIGS. 6a and 6b are cross-sectional views of stringer run-out arrangements according to another embodiments of the present invention.

### DETAILED DESCRIPTION OF THE INVENTION

FIG. 1 shows a typical torsion box of an aircraft lifting surface made up by an upper skin (not shown to facilitate the identification of the different parts), a lower skin 13 reinforced with longitudinal stringers 15 attached to the skin 13 by bonding means, a front spar 27, a rear spar 28 and ribs 21.

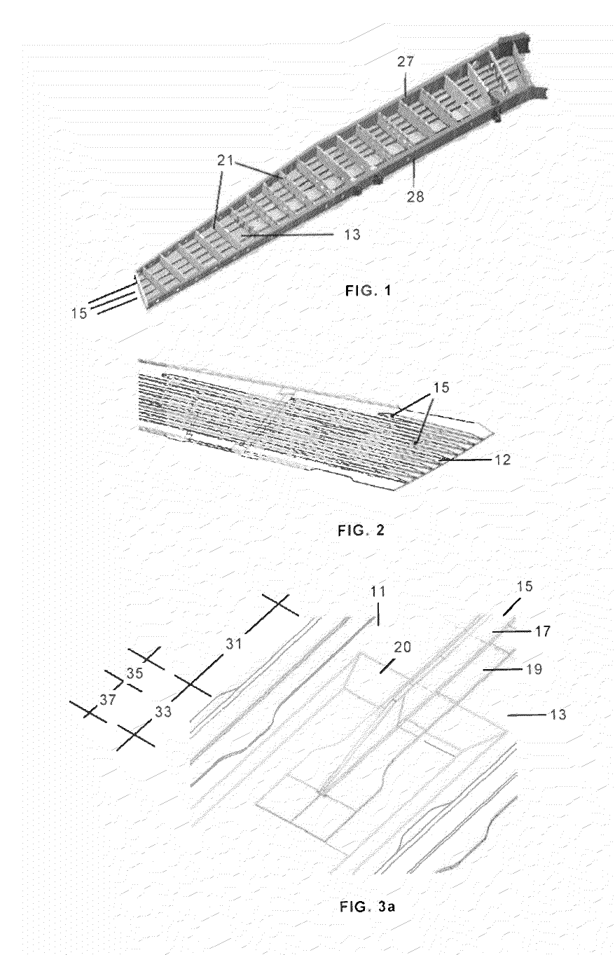

FIG. 2 shows a portion of a skin 13 stiffened with T-shaped stringers 15, some of them terminating close to the front spar 27.

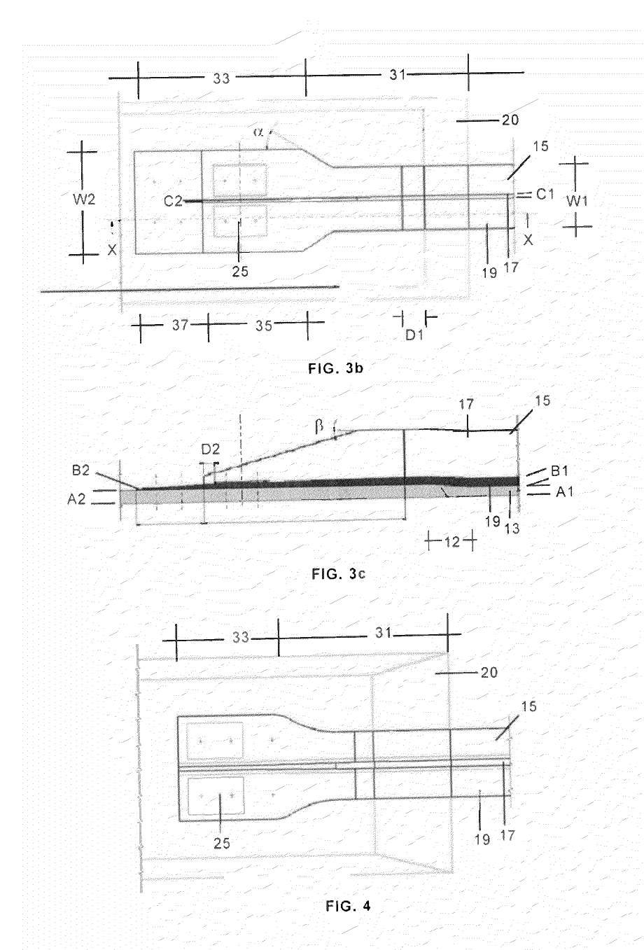

FIGS. 3a, 3b and 3c show a stringer run-out arrangement according to a first embodiment of the present invention. Its main objective is to locally reduce the load carried by a stringer 15 in a very smooth way to reduce as much as possible the load peaks that appear just at the end of the stringer 15.

The stringer 15 is a T-shaped stringer ending in a panel 11 with a web 17 and a foot 19 extending at both sides of the web 17. In its run-out zone, the stringer 15 has a first section 31 where the width of the stringer foot 19 keeps its normal value W1 (i.e. the value outside the run-out zone) in a first stretch and changes to an increased value W2 in a second stretch at an angular slope of a degrees and a second section 33 where the stringer foot 19 has a constant width W2. The stringer web 17 has a decreasing height in the run-out zone at a constant slope of β degrees (for example 18°).

Within the meaning of this invention a stringer run-out zone shall be understood as a zone of the panel 11 where a stringer 15 ends having at least one differential feature with respect to the rest of the panel 11.

The invention is also applicable to any other stringer whose configuration includes a web and a foot.

The main features of said arrangement are the following:

A local increment of the thickness of the skin 13 in the stringer run-out zone shown as a panel zone 20 in FIGS. 3a and 3b. In the panel zone 20 the skin thickness changes from a value A1 at the beginning of the stringer run-out zone to a value A2 after a transition zone 12, the increment being preferably comprised in the range 10%-25%. This local increment can be made by introducing plies with 0° orientation in order to support the load transferred by the stringer 15 and by using big ramps to allow a load transmission between the stringer 15 and the skin 13 as smooth as possible. The extension of the panel zone 20 is driven by neighbor elements, like spars and other stringers, and by the space required to locate not only the ramps used to introduce said plies but also to the clearances required by the manufacturing process and the tooling.

The stringer second section 33 comprises a first sub-section 35 where the stringer web 17 ends and a second sub-section 37 without the stringer web. If the stringer web 17 and the stringer foot 19 ended at the same place, the related peeling and shear loads peaks would overlap, causing a big load peak at the end of the stringer 15 which could start the rupture of the co-bonding line because the final load is bigger than the one allowable by the adhesive. If the stringer web 17 and the stringer foot 19 end in different places, the overlapping of the peeling and shear peaks is avoided. Specifically, the stringer foot 19 is extended after the removal of the stringer web 17 in a length big enough to install two rows of anti-peel rivets.

The foot 19 and the web 17 of said stringer 15 have a decreasing thickness in the run-out zone. They decrease, respectively, from values B1, C1 at a distance D1 from the inner border of the panel zone 20 to values B2, C2, the decrement of the thickness of the foot 19 being preferably comprised in the range 60%-80%, the decrement of the thickness of the web 17 being preferably comprised in the range 50%-70% and the distance D1 being preferably comprised in the range 30-60 mm. The foot thickness decreases preferably with a lesser slope in said first section 31 and in said first sub-section 35 than in said second sub-section 37. In both thickness reductions smooth ramps are used to transfer the load from the stringer 15 to the skin 13 avoiding any load peak or concentration due to a strong section reduction. Regarding the stringer foot thickness reduction, only external plies which have +/−45° orientations, are kept at the end of the stringer 15 in order to avoid any discontinuity in the co-bonding line.

The joining areas 25 with an intersecting rib will be placed at said first-sub-section 35 of said second section 33, having preferably its outer borders at a minimum distance D2 from the outer border of said first sub-section 35 comprised between 10-20 mm. The place where the stringer web 17 is completely removed is matched with the rib feet location in order to use it to support the peeling load peak that appears when the stringer web 17 is fully trimmed. On the other hand, the increased width W2 of said section 33 not only allows a good interface with the rib feet in terms of minimum edge distances and assembly clearances but also contributes to maximize the co-bonding area to distribute the shear efforts that appear at the end of the stringer foot 19 and reduce the shear load peak.

This first embodiment is intended for a stringer run-out zone supporting very high loads.

In the case of lower loads and according to the stress sizing analysis, some of the above-mentioned features could be unnecessary to reduce the loads or to smooth the loads transmission. In this respect, the invention also refers to the embodiments that will now be described.

FIG. 4 shows a stringer run-out arrangement according to another embodiment of the present invention that differs from the first embodiment in that the second section 33 does not comprises a sub-section 37 without the stringer web 17.

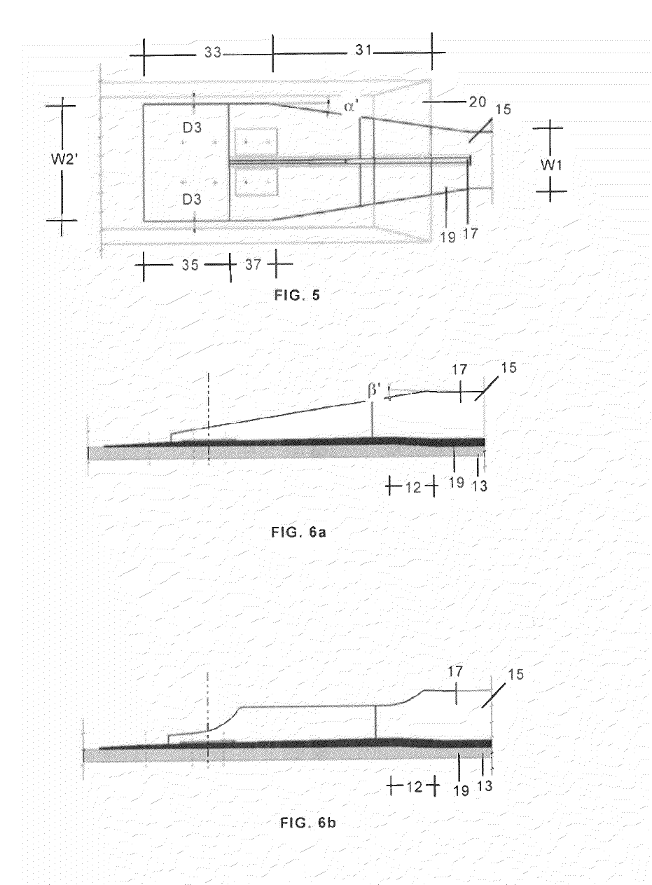

FIG. 5 shows a stringer run-out arrangement according to another embodiment of the present invention that differs from the first embodiment in that the width of the stringer foot 19 changes linearly in one stretch with the minimum angular slope α′ compatible with the geometry of the stringer run-out zone, preferably lesser than 8°, from its normal value W1 (i.e. the value outside the run-out zone) to the increased value W2′ in said first section 31 and in that the increased value W2′ is the maximum value compatible with the geometry of the run-out zone, i.e. leaving a minimum lateral distance D3 with the inner borders of the panel zone 20 with increased thickness.

FIG. 6a shows a stringer run-out arrangement according to another embodiment of the present invention that differs from the first embodiment in that the height of the stringer web 17 begins to decrease linearly very close to the beginning of the run-out zone so that the slope β is very low, preferably lesser than 12°.

FIG. 6b shows a stringer run-out arrangement according to another embodiment of the present invention that differs from the first embodiment in that the height of the stringer web 17 decreases in two stretches from the beginning of the run-out zone.

In all the above-mentioned embodiments the limits of the stringer run-out zone are defined by the panel zone 20 with increased thickness with respect to the rest of the skin 13.

In another embodiment (not shown) the stringer run-out arrangement differs from the first embodiment in that there is no local increase of the panel thickness in the run-out zone. In that case the beginning of the decreasing thickness of the foot 19 and the web 17 of said stringer 15 is what defines the beginning of the run-out zone.

Although the present invention has been fully described in connection with preferred embodiments, it is evident that modifications may be introduced within the scope thereof, not considering this as limited by these embodiments, but by the contents of the following claims.

1. Aircraft component that comprises at least one panel (11) of a composite material formed by a skin (13) and at least a stiffening stringer (15) configured by a web (17) and a foot (19) bonded to said skin (13); the stringer (15) having a run-out zone inside said panel (11) subjected to a high load level; the stringer (15) having a web (17) of decreasing height in said run-out zone and a foot (19) having a first section (31) of variable width from an initial value W1 to a final value W2 and a second section (33) with a width W2 in said run-out zone; the foot (19) and the web (17) of said stringer (15) having a decreasing thickness in said run-out zone for improving the load transfer from the stringer (15) to the skin (13).

2. Aircraft component according to claim 1, wherein:
said skin (13) has an increased thickness in said run-out zone;
said second section (33) of the stringer (15) comprises a first sub-section (35) where the stringer web (17) ends and a second sub-section (37) without a stringer web (17).

3. Aircraft component according to any of claims 1-2, wherein:
the aircraft component also comprises a rib having an intersection zone with said stringer (15) in said run-out zone;
the joining areas (25) between said rib and said stringer (15) are placed at said first sub-section (35).

4. Aircraft component according to any of claims 2-3, wherein the slope of the decrement of the thickness of the stringer foot (19) in said first section (31) and in said first sub-section (35) is lesser than in said second sub-section (37).

5. Aircraft component according to claim 4, wherein the decrement of the thickness of the stringer foot (19) in said first section (31) begins at a distance D1 of the inner border of the panel zone 20 with increased thickness comprised between 30-60 mm.

6. Aircraft component according to any of claims 2-5, wherein in said first section (31) the width of the stringer foot (19) increases linearly at the minimum slope (α′) compatible with the geometry of the component.

7. Aircraft component according to any of claims 2-6, wherein the height of the stringer web (17) decreases linearly in said first section (31) and in said first sub-section (35).

8. Aircraft component according to claim 7, wherein the height of the stringer web (17) decreases at the minimum slope (β′) possible in the run-out zone.

9. Aircraft component according to any of claims 2-6, wherein the height of the stringer web (17) decreases in one or more steps in the run-out zone.

10. Aircraft component according to claim 1, wherein the stringer web (17) ends at the end of said run-out zone and said skin (13) has an increased thickness in said run-out zone.

11. Aircraft component according to claim 10, wherein:
the aircraft component also comprises a rib having intersection zones with said stringer (15) in said run-out zone;
the joining areas (25) between said rib and said stringer (15) are placed at the second section (33) of said run-out zone.

12. Aircraft component according to claim 1, wherein said second section (33) of the stringer (15) comprises a first sub-section (35) where the stringer web (17) ends and a second sub-section (37) without a stringer web (17).

13. Aircraft component according to any of claims 1-12, wherein the decrement of the thickness of the stringer web (17) in the run-out zone is comprised between 50-70%.

14. Aircraft component according to any of claims 1-13, wherein the decrement of the thickness of the stringer foot (19) in the run-out zone is comprised between 60-80%.

15. Aircraft component according to any of claims 1-14 wherein said aircraft component is an aircraft wing.
